(19) United States
(12) Patent Application Publication
(10) Pub. No.: US 2003/0204707 A1
(43) Pub. Date: Oct. 30, 2003

(54) Real-time tracing microprocessor unit and operating method

(76) Inventor: Ching-Jer Liang, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,440

(22) Filed: Apr. 24, 2002

(51) Int. Cl. G06F 9/00

(52) U.S. Cl. 712/227; 717/128

(57) ABSTRACT

A real-time tracing microprocessor unit and its method of operation. The microprocessor unit has a trace buffer capable of holding a plurality of trace records with each record containing a non-sequential program counter value and a state bit. When the microprocessor control unit encounters a non-sequential instruction, a program counter generator produces a non-sequential program counter value. A trace buffer controller transfers the non-sequential program counter value to a trace record having an empty state bit and sets the state bit of the trace record into an occupied state. When any one of the trace records within the trace buffer are occupied, the trace buffer controller is triggered to transfer the non-sequential program counter value to a storage device.

### BACKGROUND OF INVENTION

1. Field of Invention

The present invention relates to a microprocessor unit and its operating method. More particularly, the present invention relates to a real-time tracing microprocessor unit and its operating method.

2. Description of Related Art

Real-time tracing is frequently used in program development. To initiate program development, a program developer loads a program into the development system of a microprocessor unit (MPU) so that the MPU may execute various instructions in the program. While program instructions are executed, program codes and other data are derived from the original program with great certainty. The only uncertainty is the sequential order of the program instructions. Since most instructions are executed according to the address sequence, a real-time tracer needs only to follow non-sequential instructions. Non-sequential instructions are those instructions carried out in a program when conditional branching instructions such as a jump, call, return or interrupt are encountered. Hence, if the sequential order of instructions after encountering a non-sequential command is registered, a program developer can find out the source of an error quickly. For example, the executing sequence of instructions in a program is 1, 2, 3, . . . , N (where N is a positive integer). On encountering a branching condition in the N^{th} instruction so that the program jumps to the T^{th} instruction (T is a positive integer), subsequent instructions to be executed are T+1, T+2, . . . until the end or another conditional branching occurs. Thus, as long as the address of the N^{th} node and the address of the T^{th} node are registered, the actual executing sequence of the instructions can be perfectly traced.

One type of conventional MPU has a program counter (PC) generator and eight extra leads. When a program encounters a 32-bit non-sequential instruction during execution, the PC generator will produce a non-sequential PC value. The nonsequential PC value includes a 32-bit source address and a 32-bit destination address. Thereafter, this non-sequential PC value is transferred and stored inside the tracing section of an external memory via the extra leads. In this example, a 64-bit data is transferred to the tracing section when a non-sequential instruction is encountered. In general, internal frequency (internal clocking frequency) of a MPU is a lot higher than external frequency (bus operating frequency), that is, the internal frequency is n times (where n is a positive integer very much greater than 1) bigger than the external frequency. Hence, each non-sequential instruction requires 8×n instruction cycles to store up the non-sequential PC value. If, furthermore, a second non-sequential instruction is encountered during the 8×n instruction cycles, the MPU will stop executing the current instruction (because internal frequency is many times higher than external frequency). The MPU will resume a normal operating mode until all the non-sequential instruction data are completely transferred to the tracing section. Since the MPU is not operating in a normal mode during data transfer, real-time tracing of the program instructions is temporary lost.

In a second type of conventional MPU, the MPU system includes a PC generator, a trace buffer and a trace buffer controller. When the program executes a non-sequential instruction, the PC generator will produce a non-sequential PC value. The trace buffer controller transfers the non-sequential PC value to the trace buffer. Interrupts are set at various points along the program. When the program is executed to one of these interrupt points, the MPU will enter into an emulation mode. In the emulation mode, an external in-circuit emulator (ICE) controller may read out the non-sequential PC value from the tracing buffer. With this arrangement, the n non-consecutive points (if depth of the trace buffer is n) before the interrupt point are registered. However, if m (where m>n) jumps have occurred before the interrupt point, some non-consecutive point data is permanently lost. Ultimately, real-time tracing function is also lost.

From the aforementioned description, major drawbacks of conventional techniques may be summarized to include:

1. When two or more non-consecutive instructions are encountered during a program execution, the MPU must step into a waiting state. Hence, real-time tracing function is lost.

2. The non-consecutive PC value inside the trace buffer is not read out in real-time. Instead, only the non-consecutive instruction before a preset interrupt point can be read. Consequently real-time tracing function is similarly lost.

### SUMMARY OF INVENTION

Accordingly, one object of the present invention is to provide a real-time tracing microprocessor unit and its operating method. In this invention, a trace buffer capable of holding several trace records with each record registering a non-sequential program counter value and a state bit is set up inside the microprocessor unit (MPU). Hence, frequency of entrance into a waiting mode is greatly reduced so that real-time tracing function can be achieved.

To achieve these and other advantages and in accordance with the purpose of the invention, as embodied and broadly described herein, the invention provides a real-time tracing microprocessor unit for real-time recording steps carried out in a program execution. The real-time tracing MPU includes a microprocessor control unit, a program counter generator, a trace buffer and a trace buffer controller. The microprocessor controller decodes and executes a number of instructions in the program. The program counter generator is coupled to the microprocessor control unit. When the microprocessor control unit encounters a non-sequential instruction, the program counter generator will produce a non-sequential program counter value. The trace buffer is coupled to the program counter generator. The trace buffer stores up trace records. Each trace record registers a non-sequential program counter value and a state bit. The trace buffer controller is coupled to the microprocessor control unit and the trace buffer for sending the non-sequential program counter value to a trace record having an empty state and setting the state bit of the trace record to an occupied state. When the state bits of all trace records are occupied, the trace buffer controller will trigger the microprocessor unit into a circuit emulation mode so that the non-sequential program counter value is transferred to a storage device.

This invention also provides a method of operating a real-time tracing microprocessor unit. The microprocessor unit includes a trace buffer for holding trace records with each record registering a non-sequential program counter value and a state bit. The operating method includes the following steps. First, when the microprocessor unit encounters a non-sequential instruction in a program execution, a non-sequential program counter value is produced. The non-sequential program counter value is sent to any one of the trace records still in an empty state and the state bit of that particular trace record is set to an occupied state. When the state bits of all trace records are set to the occupied state, the trace buffer controller triggers the microprocessor unit into a circuit emulation mode. Thereafter, the non-sequential program counter value of all the trace records in the occupied state is read out.

In one preferred embodiment of this invention, the operating method further includes the following steps. The state bit of the trace record is reset back to an empty state after the non-sequential program counter value with the trace record is read out. The microprocessor unit then returns to a normal operating mode and continues with the program execution.

In another preferred embodiment of this invention, the operating method further includes the following steps. When the state bit of any trace records are set to an occupied state, extra leads on the microprocessor unit are employed to transfer the non-sequential program counter value inside the trace record in an occupied state to a trace section within an external memory. After transferring the non-sequential program counter value away, the state bit of the trace record is returned to an empty state.

In brief, the microprocessor unit of this invention has a built-in trace buffer for holding trace records such that each trace record is able to store a non-sequential program counter value and a state bit. Thus, the frequency of the microprocessor unit proceeding into a waiting mode is reduced. In addition, when the state bit of all trace records is set to an occupied state, the trace buffer controller will automatically terminate program execution and trigger the microprocessor unit into a circuit emulation mode so that the non-sequential program counter value is transferred to a storage device. Hence, real-time recording function is maintained. This invention may also employ extra leads on the microprocessor unit to transfer a non-sequential program counter value inside the trace record to the trace section of an external memory when any one of the trace records are occupied. Therefore, the number of times the microprocessor unit steps into the circuit emulation mode is greatly reduced and optimal real-time recording function is attained.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing a real-time tracing microprocessor unit according to a first preferred embodiment of this invention; and

FIG. 2 is a block diagram showing a real-time tracing microprocessor unit according to a second preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

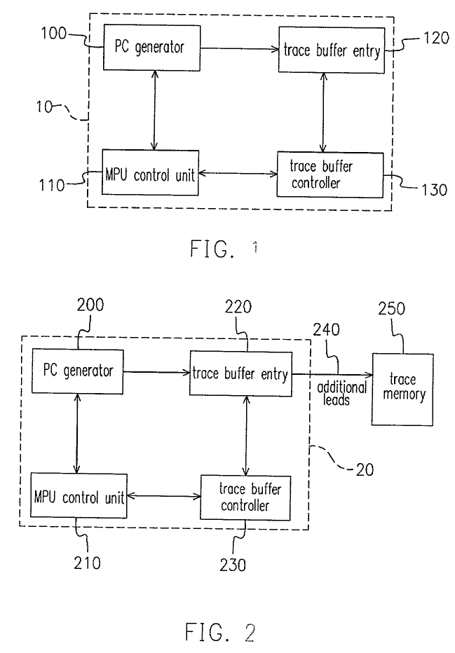

FIG. 1 is a block diagram showing a real-time tracing microprocessor unit according to a first preferred embodiment of this invention. The microprocessor unit (MPU) 10 executes the program in a program segment. The MPU 10 includes a MPU control unit 110, a program counter (PC) generator 100, a trace buffer 120 and a trace buffer controller 130. The MPU control unit 110 decodes and executes a number of instructions in the program. The PC generator 100 is coupled to the MPU control unit 110. When the MPU control unit 110 encounters a non-sequential instruction, the PC generator 100 produces a non-sequential program counter value. The non-sequential PC value includes a source address and a destination address. The trace buffer 120 is coupled to the PC generator 100. The trace buffer 120 is capable holding a plurality of trace records with each record containing a non-sequential PC value and a state bit. The trace buffer controller 130 is coupled to the MPU control unit 110 and the trace buffer 120 for transferring the non-sequential PC value into one of the trace records having an empty state bit. After sending the non-sequential PC value to the trace record, the state bit of the particular trace record is changed to an occupied state. When the state bits of all trace records are in the occupied state, the MPU 10 is triggered into an in-circuit emulation (ICE) mode so that the non-sequential PC value is sent to an external storage device.

After sending the non-sequential PC value to the storage device, the trace buffer controller 130 resets the state bit of the trace record to an empty state so that the MPU 10 may operate in a normal execution mode to continue with the program execution.

The MPU 10 operates according to the following steps. First, when the MPU encounters a non-sequential instruction, a non-sequential PC value is produced. The non-sequential PC value is transferred into any one of the trace records having an empty state bit. The state bit of the particular trace record is then changed to an occupied state. When the state bit of all trace records are in an occupied state, the MPU (10) is triggered into the ICE mode. Thereafter, the non-sequential PC value in trace records having an occupied state bit is read out and sent to the external storage device. The state bit of the trace records reverts back to an empty state as soon as the non-sequential PC value is read out so that the MPU 10 returns to operate in the normal execution mode.

FIG. 2 is a block diagram showing a real-time tracing microprocessor unit according to a second preferred embodiment of this invention. The microprocessor unit (MPU) 20 executes the program in a program segment. The MPU 20 includes a MPU control unit 210, a program counter (PC) generator 200, a trace buffer 220, a trace buffer controller 230 and a few extra leads 240. The MPU control unit 210 decodes and executes a number of instructions in the program. The PC generator 200 is coupled to the MPU control unit 210. When the MPU control unit 210 encounters a non-sequential instruction, the PC generator 200 produces a non-sequential program counter value. The non-sequential PC value includes a source address and a destination address. The trace buffer 220 is coupled to the PC generator 200. The trace buffer 220 is capable of holding a plurality of trace records with each record containing a non-sequential PC value and a state bit. The trace buffer controller 230 coupled to the MPU control unit 210 and the trace buffer 220 for transferring the non-sequential PC value into one of the trace records having an empty state bit. After sending the non-sequential PC value to the trace record, the state bit of the particular trace record is changed to an occupied state. When the state bits of all trace records are in the occupied state, the MPU 20 is triggered into the ICE mode so that the non-sequential PC value is sent to an external storage device. The additional external leads 240 are used for transferring non-sequential PC value synchronously (or in real-time) to the trace section 250 of an external memory when the state bits of any one of the trace records are in an occupied state.

After sending the non-sequential PC value to the storage device, the trace buffer controller 230 resets the state bit of the trace record to an empty state so that the MPU 20 may operate in a normal execution mode to continue with the program execution.

The MPU 20 operates according to the following steps. First, when the MPU 20 encounters a non-sequential instruction, a non-sequential PC value is produced. The non-sequential PC value is transferred into any one of the trace records having an empty state bit. The state bit of the particular trace record is then changed to an occupied state.

When the state bits of any one of the trace records are in an occupied state, the extra leads 240 are employed to transfer the non-sequential PC value in the trace record having an occupied state to the trace section 250 of the external memory.

Immediately thereafter, the state bit of the trace record originally holding the non-sequential PC value is returned to an empty state.

In addition, if the state bits of all the trace records are in the occupied state, the MPU 20 will be triggered into the ICE mode. Thereafter, the non-sequential PC value in trace records having an occupied state bit is read out and sent to the external storage device. The state bit of the trace records reverts back to an empty state as soon as the non-sequential PC value is read out so that the MPU 20 returns to operate in the normal execution mode.

Since any non-sequential PC value in the trace buffer 220 will immediately trigger the transfer of the non-sequential PC value to the trace section 250 of an external memory via the extra leads 240, the probability of having the trace buffer 220 fully occupied is considerably lowered. Consequently, the frequency of the MPU 20 stepping into the ICE mode is greatly reduced and the real-time tracing function is improved. The only drawback for this operating method is the provision of extra hardware resources including the extra leads 240 and the external memory.

In conclusion, major advantages of this invention include:

1. The MPU of this invention has a built-in trace buffer for holding trace records such that each trace record is able to store a non-sequential program counter value and a state bit. Thus, frequency of the microprocessor unit proceeding into a waiting mode is reduced.

2. When the state bit of all trace records is set to an occupied state, the trace buffer controller will automatically terminate program execution and trigger the microprocessor unit into a circuit emulation mode so that the non-sequential program counter value is transferred to a storage device. Hence, the real-time recording function is maintained.

3. This invention may also employ extra leads on the microprocessor unit to transfer non-sequential program counter value inside the trace record to the trace section of an external memory when any one of the trace records are occupied.

Therefore, the number of times having the microprocessor unit stepping into the circuit emulation mode is greatly reduced and optimal real-time recording function is attained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A real-time tracing microprocessor unit (MPU) for executing a program within a program segment, comprising:
a microprocessor control unit for decoding and executing the plurality of instructions within the program;
a program counter generator coupled to the microprocessor control unit for generating a non-sequential program counter value on encountering a non-sequential instruction;
a trace buffer coupled to the program counter generator, wherein the trace buffer is capable of holding a plurality of trace records with each trace record containing the non-sequential program counter value and a state bit; and
a trace buffer controller coupled to the microprocessor control unit and the trace buffer for transferring the non-sequential program counter value to one of the trace record having an empty state bit and setting the state bit of that the one of the trace records into an occupied state, and as all trace records are fully occupied, triggering the microprocessor unit into an in-circuit emulation mode so that the non-sequential program counter value is sent to a storage device.

2. The MPU of claim 1, wherein the MPU further includes a plurality of extra leads for sending the non-sequential program counter value to a trace section of the storage device when the state bit of any one of the trace records within the trace buffer is at the occupied state.

3. The MPU of claim 1, wherein the non-sequential program counter value includes a source address and a destination address.

4. The MPU of claim 1, wherein both the program segment and the trace section reside within an external memory unit.

5. The MPU of claim 4, wherein the storage device includes the external memory unit.

6. The MPU of claim 1, wherein after sending the non-sequential program counter value to the storage device, the state bit of the trace record originally holding the non-sequential program counter value is reset to an empty state and the microprocessor unit is triggered back to a normal operating mode.

7. A method of operating a real-time tracing microprocessor unit (MPU) having a trace buffer for holding a plurality of trace records with each trace record containing a non-sequential program counter value and a state bit, the method comprising the steps of:
generating a non-sequential program counter value when the microprocessor unit encounters a non-sequential instruction;
transferring the non-sequential program counter value to one of the trace records having an empty state bit and setting the state bit of that particular trace record to occupied state;
triggering the microprocessor unit to step into an in-circuit emulation mode when all the trace records are occupied; and
reading out the non-sequential program counter value in all the trace records having an occupied state bit.

8. The method of claim 7, wherein the real-time tracing further includes the sub-steps:
setting the state bit of the trace records originally holding the non-sequential program counter value to empty state after reading out the non-sequential program counter value; and
returning the microprocessor unit to a normal operating mode so that normal program execution is resumed.

9. The method of claim 7, wherein the microprocessor unit has extra leads and the operating method further includes the sub-steps:
automatically transferring the non-sequential program counter value from any one of the trace records of the occupied trace buffer to a trace section; and
resetting the state bit of the trace records whose non-sequential program counter value has just been transferred to empty state.

10. The MPU operating method of claim 7, wherein the non-sequential program counter value includes a source address and a destination address.
